(19) United States
(12) Patent Application Publication
(10) Pub. No.: US 2009/0225067 A1
(43) Pub. Date: Sep. 10, 2009

(54) Display Panel and Display Device

(76) Inventors: Kazuhiko Yoda, Nara (JP); Toshiya Aoki, Nara (JP)

Correspondence Address: HARNESS, DICKEY & PIERCE, P.L.C., P.O. BOX 8910, RESTON, VA, 20195, US

(21) Appl. No.: 11/992,518

(22) PCT Filed: May 31, 2006
(86) PCT No.: PCT/JP2006/310843

§ 371 Date: Mar. 25, 2008

(30) Foreign Application Priority Data
Sep. 28, 2005 (JP) 2005-282448

(51) Int. Cl. G06F 3/038; G09G 3/20

(52) U.S. Cl. 345/211; 345/55

(57) ABSTRACT

In one embodiment of the present invention, a display panel is disclosed in which a plurality of scanning lines and a plurality of signal lines are formed in a matrix shape, and in which driving transistors controlled to be turned ON/OFF by scanning voltages to be applied to scanning lines and pixel circuits connected with the signal lines through the driving transistors are disposed at the individual intersections between the scanning lines and the signal lines. The display panel includes a plurality of detecting transistors having their individual gates connected with the individual scanning lines. The plural detecting transistors have their drains commonly connected, and a detection signal indicating the logical sum of the ON states of the detecting transistors are outputted from the commonly connected drains.

### TECHNICAL FIELD

The present invention relates to a display panel having a function of detecting the wiring condition of signal lines and/or scanning lines. The present invention also relates to a display device having such a display panel.

### BACKGROUND ART

One method of detecting defects in scanning lines and signal lines in a display device using a liquid crystal display panel or the like is to directly touch each wiring conductor with a test probe. As displays come to have increasingly high resolutions and increasingly large screens, however, that method becomes increasingly difficult to adopt. In view of this, various methods for inspecting scanning lines and/or signal lines for defects have been proposed.

For example, according to Patent Document 1 listed below, in an output portion of a horizontal scanning circuit, a group of transfer transistor switches is provided, and the terminal ends of signal lines in respective columns are connected to the gates of a group of inspection switches. When pulses for inspection are fed to the group of transfer transistor switches, the group of inspection switches yields outputs, based on the waveforms of which the signal lines are inspected.

For another example, according to Patent Document 2 listed below, one ends of scanning lines are connected via capacitive elements to the gates of inspection transistors. In an inspection mode, when scanning pulses are fed to one scanning line after another, the inspection transistors yield outputs, based on the waveforms of which the scanning lines are inspected.

For yet another example, according to Patent Document 3 listed below, inspection cells each composed of a switching transistor, a capacitive element, etc. are provided one for each scanning line to build an inspection circuit. When, for example, pulses for inspection are fed as an image signal, defective spots are located.

### Patent Document 1: Japanese Patent No. 2618042

### Patent Document 2: JP-A-H10-97203

### Patent Document 3: JP-A-2004-199054

### DISCLOSURE OF THE INVENTION

### Problems to be Solved by the Invention

Inconveniently, however, the method of Patent Document 1 mentioned above requires a group of transfer transistor switches; the method of Patent Document 2 mentioned above requires capacitive elements one for each of inspection transistors; the method of Patent Document 3 mentioned above requires capacitive elements; thus, these methods all require many elements for inspection. Moreover, the methods of Patent Documents 1 to 3 mentioned above all assume that scanning lines etc. are inspected in an inspection mode provided separately from actual operation, and are difficult to adopt for inspection in actual operation.

In view of the above, it is an object of the present invention to provide a display panel and a display device that allow detection of wiring condition of scanning lines and/or signal lines in actual operation.

### Means for Solving the Problem

To achieve the above object, a display panel according to the present invention has a plurality of scanning lines and a plurality of signal lines that are formed to form a matrix, and has, respectively at the intersections between the scanning lines and the signal lines, drive switching elements that are turned on and off according to scanning voltages fed to the scanning lines and pixel circuits that are connected via the drive switching elements to the signal lines. Here, the display panel has detection switching elements of which the control electrodes are connected respectively to the scanning lines. The first conducting electrodes of the detection switching elements are connected together so that, from these first conducting electrodes thus connected together, a detection signal representing the logical sum of any on-state among the detection switching elements is outputted.

The scanning lines are individually fed with scanning voltages for turning on and off the drive switching elements. Having their control electrodes connected to the scanning lines, the detection switching elements are also turned on and off according to the corresponding scanning voltages. If, however, any scanning line is broken or otherwise defective, the scanning voltage applied to it is not accurately transmitted to the corresponding detection switching element, and thus the detection signal contain information on line breakage or the like. Thus, based on the detection signal, it is possible to detect the wiring condition of the individual scanning lines with an extremely small number of elements. Moreover, since the detection signal is derived by use of the scanning voltages for turning the drive switching elements on and off, it is possible to detect the wiring condition of the scanning lines in actual operation.

Specifically, for example, the detection switching elements each turn on when receiving at the control electrodes thereof a first-level scanning voltage that turns the drive switching elements on, and turn off when receiving at the control electrodes thereof a second-level scanning voltage that turns the drive switching elements off.

These detection switching elements have characteristics similar to those of the drive switching elements, and thus can be formed by a single process by which the drive switching elements are formed.

That is, the drive switching elements and the detection switching elements may be transistors formed on a single substrate by a single process.

This eliminates the need to provide a separate process for forming a circuit for detecting the wiring condition of the scanning lines.

A first display device according to the present invention is provided with: the display panel described above; a scanning line driver that feeds the first-level scanning voltage to one after another of the scanning lines; and a first wiring condition detector that detects, based on the detection signal, the wiring condition of the scanning lines one by one.

For example, in the first display device described above, the scanning voltage from the scanning line driver is fed to the scanning lines via first protection switching elements provided one for each of the scanning lines, and the first wiring condition detector identifies as an abnormal scanning line any scanning line across which the transmission of the first-level scanning voltage to the corresponding one of the detection transistors is abnormal, and turns off the corresponding one of the first protection switching elements which is inserted in the thus identified abnormal scanning line.

This makes it possible to prevent an abnormal current from continuing to flow when any scanning line becomes abnormal.

For example, the first display device described above is further provided with: a signal line driver that is connected to the first ends of the signal lines; and a second wiring condition detector that is connected to the second ends of the signal lines. Here, while the scanning line driver is feeding the second-level scanning voltage to all the scanning lines, the signal line driver feeds an inspection voltage having a predetermined level to the signal lines so that, based on how the inspection voltage is transmitted, the second wiring condition detector detects the wiring condition of the signal lines.

With this configuration, it is possible to detect the wiring condition of the signal lines in actual operation.

To achieve the above object, a second display device according to the present invention has: a display panel having a plurality of scanning lines and a plurality of signal lines that are formed to form a matrix, and having, respectively at the intersections between the scanning lines and the signal lines, drive switching elements that are turned on and off according to scanning voltages fed to the scanning lines and pixel circuits that are connected via the drive switching elements to the signal lines; a signal line driver that is connected to the first ends of the signal lines; and a scanning line driver that feeds one after another of the scanning lines with a first-level scanning voltage that turns the drive switching elements on. Here, the display device is further provided with: a second wiring condition detector connected to second ends of the signal lines. While the scanning line driver is feeding all the scanning lines with a second-level scanning voltage that turns the drive switching elements off, the signal line driver feeds an inspection voltage having a predetermined level to the signal lines so that, based on how the inspection voltage is transmitted, the second wiring condition detector detects the wiring condition of the signal lines.

In actual operation, the plurality of scanning lines are fed, one after another, with the first-level scanning voltage that turns the drive switching elements on. Here, there usually exist periods during which the second-level scanning voltage that holds the drive switching elements off is fed to all the scanning lines. By use of these periods, the inspection voltage having a predetermined level is fed to the signal lines so that, based on how the inspection voltage is transmitted, the wiring condition of the signal lines is detected. Thus, with the above configuration, it is possible to detect the wiring condition of the signal lines in actual operation.

For example, in the second display device described above, the signal line driver is connected to the signal lines via second protection switching elements provided one for each of the signal lines, and the second wiring condition detector identifies as an abnormal signal line any signal line across which the transmission of the inspection voltage to the second wiring condition detector is abnormal, and turns off the corresponding one of the second protection switching elements which is inserted in the thus identified abnormal signal line.

This makes it possible to prevent an abnormal current from continuing to flow when any signal line becomes abnormal.

### Advantages of the Invention

As described above, with a display panel and a display device according to the present invention, it is possible to detect the wiring condition of scanning lines and/or signal lines in actual operation.

### BRIEF DESCRIPTION OF DRAWINGS

FIG. 1 A block diagram showing the configuration of a display unit included in a display device according to the first embodiment of the present invention.

FIG. 2 A waveform diagram showing the relationship between the scanning voltage and the detection signal in the display unit shown in FIG. 1 over the display period of one screen (with all scanning lines normal).

FIG. 3 A waveform diagram showing the relationship between the scanning voltage and the detection signal in the display unit shown in FIG. 1 over the display period of one screen (with some scanning lines abnormal).

FIG. 4 A block diagram showing the configuration of a modified example of the display unit shown in FIG. 1.

FIG. 5 A waveform diagram showing the relationship between the scanning voltage and the detection signal in the display unit shown in FIG. 4 over the display period of one screen (with all scanning lines normal).

FIG. 6 A waveform diagram showing the relationship between the scanning voltage and the detection signal in the display unit shown in FIG. 4 over the display period of one screen (with some scanning lines abnormal).

FIG. 7 A block diagram showing the configuration of a modified example of the display unit shown in FIG. 1 (FIG. 4).

FIG. 8 A waveform diagram showing the relationship between the scanning voltage and the detection signal in the display unit shown in FIG. 7 over the display period of one screen (with all scanning lines normal).

FIG. 9 A block diagram showing the configuration of a display unit included in a display device according to the second embodiment of the present invention.

FIG. 10 A block diagram showing the configuration of a display unit included in a display device according to the third embodiment of the present invention.

FIG. 11 A waveform diagram showing the scanning voltage in the display unit shown in FIG. 10 over the display period of one screen.

FIG. 12 A diagram showing an example of the configuration of the second wiring condition detector shown in FIG. 10.

FIG. 13 A block diagram showing the configuration of a modified example of the display unit shown in FIG. 10.

FIG. 14 A diagram showing the overall configuration of a vehicle-mounted system according to the fourth embodiment of the present invention.

FIG. 15 A diagram showing the contents of the event conversion table shown in Fig. 14.

FIG. 16 A diagram showing an example of the image displayed on the display panel shown in FIG. 14.

FIG. 17 A diagram showing another example of the image displayed on the display panel shown in FIG. 14.

### LIST OF REFERENCE SYMBOLS

1, 1a, 1b, 1c, 1d Display Unit
2, 2a Display Panel
3 Gate Driver
4 Source Driver
5, 5a, 5b, 5c First Wiring Condition Detector
6 Group of Detection Transistors
7 Charge Feeder
8 Groups of Protection Switches
9 Second Wiring Condition Detector
S0-S4 Signal Lines
G0-G4 Scanning Lines
T00-T44, T00a-T44a Drive Transistors
TG0-TG4, TG0a-TG4a Detection Transistors
P00-P44 Pixel Circuits
SW0-SW4, SW0a-SW4a Protection Switching Elements

### BEST MODE FOR CARRYING OUT THE INVENTION

### First Embodiment

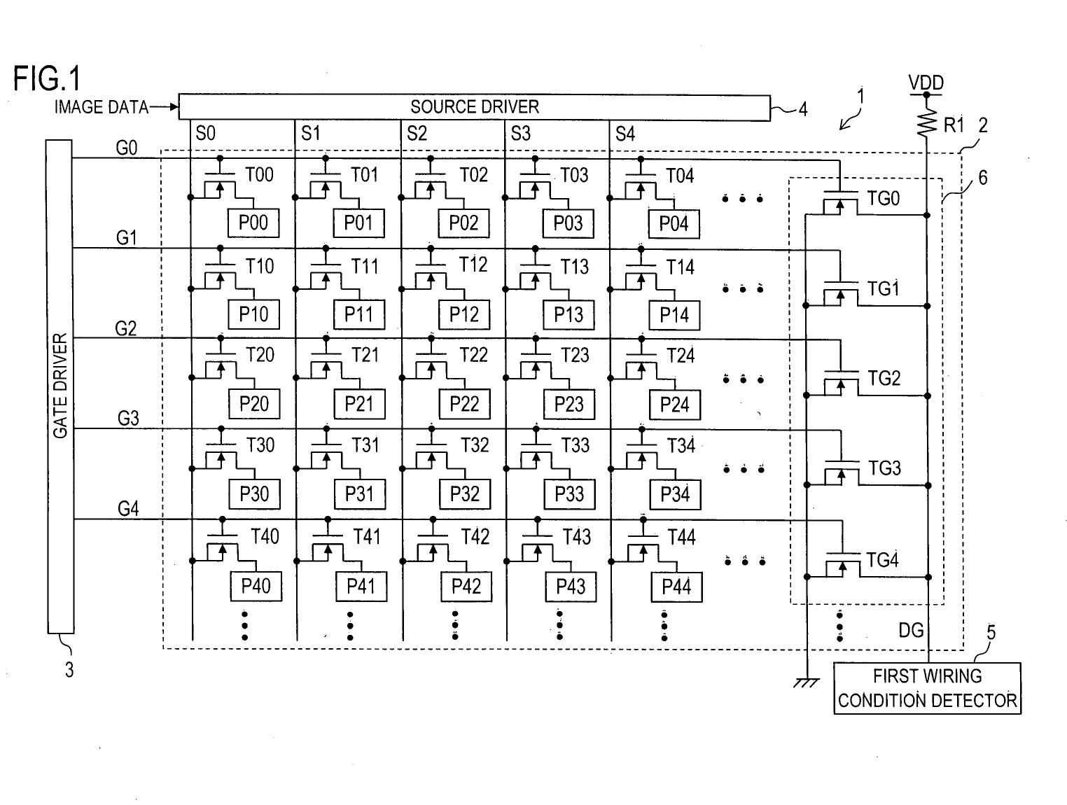

As a first embodiment of the present invention, how it is applied to a display device will be described specifically below with reference to the drawings. FIG. 1 is a block diagram showing the configuration of a display unit 1 included in a display device according to the first embodiment.

The display unit 1 has, or is composed of, a display panel 2, a gate driver 3, a data driver 4, and a first wiring condition detector 5. The display panel 2 (and 2a described later) is, for example, a liquid crystal display panel, an organic EL (electroluminescence) display panel, an inorganic EL display panel, a plasma display panel, or the like. For the sake of concreteness, the following description assumes that the display panel 2 (and 2a described later) is a liquid crystal display panel.

In the display panel 2, a plurality of scanning lines G0, G1, G2, G3, G4, . . . and a plurality of signal lines S0, S1, S2, S3, S4, . . . are arranged to cross each other, with an unillustrated insulating film interposed between the former and the latter; that is, they are arranged to form a matrix.

At each of the intersections between the scanning lines and the signal lines, there are provided a drive transistor and a pixel circuit. Specifically, at the intersection between the scanning line G0 and the signal line S0, there are provided a drive transistor T00 and a pixel circuit P00. Likewise, at the intersection between the scanning line G0 and the signal line S1, there are provided a drive transistor T01 and a pixel circuit P01, and, at the intersection between the scanning line G1 and the signal line S0, there are provided a drive transistor TI0 and a pixel circuit P10. In generalized terms, when m and n are arbitrary natural numbers, at the intersection between the scanning line Gm and the signal line Sn, there are provided a drive transistor Tmn and a pixel circuit Pmn.

For the sake of concreteness and simplicity, in the description of this and all the following embodiments, focus is placed, in principle, on the scanning lines G0, G1, G2, G3, and G4 and the signal lines S0, S1, S2, S3, and S4; with the other elements, focus is placed on their parts connected to the scanning lines G0 to G4 and the signal lines S0 to S4. Accordingly, even where the scanning lines G0, G1, G2, G3, G4, . . . for instance, are referred to as the scanning lines G0 to G4 or the like, the relevant description applies, as well as to the scanning lines G0 to G4 or the like, to the other scanning lines (for example, the scanning line G5) or the like.

The drive transistors (drive switching elements) T00 to T44 are thin-film transistors formed with amorphous silicon or the like on an insulating substrate (unillustrated) such as a glass substrate, and are formed as N-channel insulated-gate field-effect transistors.

Each of the pixel circuits P00 to P44 has a pixel electrode and a common electrode, with a liquid crystal layer interposed between the former and the latter (none of those electrodes are illustrated). In each of the pixel circuits P00 to P44, capacitive coupling between a pixel electrode and a common electrode produces pixel capacitance.

The pixel electrodes of the pixel circuits P00 to P44 are connected to the drains of the corresponding drive transistors T00 to T44. Specifically, the pixel electrode of the pixel circuit P00 is connected to the drain of the drive transistor T00, and the pixel electrode of the pixel circuit P01 is connected to the drain of the drive transistor T01. Put in generalized terms using m and n mentioned above, the pixel electrode of the pixel circuit Pmn is connected to the drain of the drive transistor Tmn. On the other hand, the common electrodes of the pixel circuits P00 to P44 are connected together so as to be collectively fed with a common potential.

The gate (control electrode) and the source of the drive transistor arranged at a given intersection are connected to the scanning line and the signal line, respectively, that form the intersection. Specifically, for example, the gate and the source of the drive transistor T00 are connected to the scanning line G0 and the signal line S0, respectively, and the gate and the source of the drive transistor T01 are connected to the scanning line G0 and the signal line S1, respectively. Put in generalized terms using m and n mentioned above, the gate and the source of the drive transistor Tmn are connected to the scanning line Gm and the signal line Sn, respectively. The display panel 2 is further provided with a group 6 of detection transistors. The group 6 of detection transistors consists of the same number of detection transistors (detection switching elements) TG0, TG1, TG2, TG3, and TG4 as the total number of scanning lines. The gates (control electrodes) of the detection transistors TG0, TG1, TG2, TG3, and TG4 are connected to the scanning lines G0, G1, G2, G3, and G4, respectively. The drains (first conducting electrodes) of the detection transistors TG0 to TG4 are connected together so as to be collectively fed with a supply voltage VDD (for example, 5V) via a resistor R1. Similarly, the sources of the detection transistors TG0 to TG4 are connected together so as to be collectively fed with a reference potential of 0 V (connected to a ground line). The detection transistors TG0 to TG4, like the drive transistors T00 to T44, are thin-film transistors formed with amorphous silicon or the like on an insulating substrate such as a glass substrate, and are formed as N-channel insulated-gate field-effect transistors. The detection transistors TG0 to TG4 and the drive transistors T00 to T44 may be formed on a single substrate by a single process for forming thin-film transistors.

The first wiring condition detector 5 receives, as a detection signal DG, the signal that appears at the drains, connected together, of the detection transistors TG0 to TG4. Based on the detection signal DG, the first wiring condition detector 5 checks whether the wiring condition of the scanning lines G0 to G4 is normal or abnormal. Here, a “normal” wiring condition is one in which a given wiring conductor is not broken, short-circuited, or otherwise defective and thus can transmit a signal (voltage) as it is meant to; by contrast, an “abnormal” wiring condition is one in which a given wiring conductor is broken, short-circuited, or otherwise defective and thus cannot transmit a signal (voltage) as it is meant to. The first wiring condition detector 5 plus the group 6 of detection transistors may be regarded as a wiring condition detector.

The gate driver 3 is composed of shift registers or the like. In synchronism with a timing signal (clock signal) fed from a timing generator (unillustrated), the gate driver 3 feeds the scanning lines G0 to G4 sequentially with a high-level scanning voltage (first-level scanning voltage) for turning the corresponding drive transistors on. Specifically, here, a high-level scanning voltage is a comparatively high voltage of, for example, 10 to 20 V (volts); on receiving a high-level scanning voltage at its gate, any of the drive transistors T00 to T44 turns on; likewise, on receiving a high-level scanning voltage at its gate, any of the detection transistors TG0 to TG4 turns on.

The gate driver 3 feeds each of the scanning lines G0 to G4 with either a high-level scanning voltage as mentioned above or a low-level scanning voltage. Here, a low-level scanning voltage (second-level scanning voltage) is a comparatively low voltage of, for example, 0 V for turning a drive transistor off; on receiving a low-level scanning voltage at its gate, any of the drive transistors T00 to T44 turns off, likewise, on receiving a low-level scanning voltage at its gate, any of the detection transistors TG0 to TG4 turns off.

As shown in FIG. 1, one ends of the scanning lines G0 to G4 are connected to the gate driver 3, and the other ends (terminal ends) of the scanning lines G0 to G4 are connected to the gates of the detection transistors TG0 to TG4. Thus, between the node where the scanning line G0 is connected to the gate driver 3 and the gate of the detection transistor TG0, there lie the nodes where the scanning line G0 is connected to the gates of the drive transistors T00 to T04; likewise, between the node where the scanning line G1 (G2, G3, or G4) is connected to the gate driver 3 and the gate of the detection transistor TG1 (TG2, TG3, or TG4), there lie the nodes where the scanning line G1 (G2, G3, or G4) is connected to the gates of the drive transistors T10 to T14 (T20 to T24, T30 to T34, or T40 to T44).

The source driver 4 receives image data representing the image to be displayed on the display panel 2, and feeds signal voltages according to the image data to the signal lines S0 to S4 with the timing according to the above-mentioned timing signal. These signal voltages have varying voltages between, for example, about 0 and 3 V depending on the contents of the image data.

The gate driver 3, the source driver 4, etc. are fed with supply voltages, for driving, from a unillustrated power supply circuit.

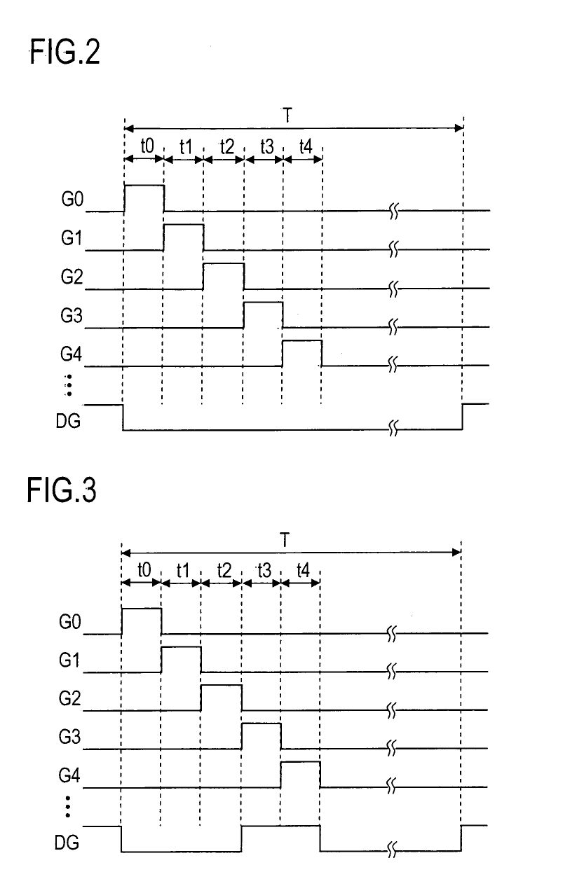

Next, a description will be given of the method by which the wiring condition of the scanning lines is detected in the display unit 1 configured as described above. FIGS. 2 and 3 are waveform diagrams showing the relationship between the scanning voltage and the detection signal DG over the display period of one screen. FIGS. 2 and 3 each show, from top, the voltage waveform appearing on the scanning line G0, the voltage waveform appearing on the scanning line G1, the voltage waveform appearing on the scanning line G2, the voltage waveform appearing on the scanning line G3, the voltage waveform appearing on the scanning line G4, and the voltage waveform of the detection signal DG.

FIG. 2 shows the waveforms observed when all the scanning lines are normal. First, with reference to FIG. 2, the method of detecting the wiring condition of the scanning lines will be described.

The display period of one screen (the one-frame period) on the display panel 2 is represented by T. In a case where the frame frequency is 60 Hz (hertz), T is about 16.7 msec (milliseconds). When T divided by the total number of scanning lines is represented by t, within the display period of one screen, the scanning lines G0 to G4 are fed, one after another, with a high-level scanning voltage, each for a period of t (or each for a period slightly shorter than a period of t).

The period starting at the start of the display period of one screen and ending at the end of the period of t thereafter is referred to as period t0; after the end of period t0, every period of t that passes is referred to as period t1, t2, t3, t4 . . . . When period t0 starts, of the scanning lines G0 to G4, which all have been receiving a low-level scanning voltage until then, the scanning line G0 alone starts to be fed with a high-level scanning voltage. During period t0, the pixel circuits P00 to P04 corresponding to the scanning line G0 are fed with signal voltages according to image data from the source driver 4 via the signal lines S0 to S4 and the drive transistors T00 to T04.

When period t0 ends, period t1 starts, at which point the scanning voltage fed to the scanning line G0 is turned low and instead the scanning line G1 alone starts to be fed with a high-level scanning voltage. During period t1, the pixel circuits P10 to P14 corresponding to the scanning line G1 are fed with signal voltages according to image data from the source driver 4 via the signal lines S0 to S4 and the drive transistors T10 to T14.

When period t1 ends, period t2 starts, at which point the scanning voltage fed to the scanning line G1 is turned low and instead the scanning line G2 alone starts to be fed with a high-level scanning voltage; when period t2 ends, period t3 starts, at which point the scanning voltage fed to the scanning line G2 is turned low and instead the scanning line G3 alone starts to be fed with a high-level scanning voltage; when period t3 ends, period t4 starts, at which point the scanning voltage fed to the scanning line G3 is turned low and instead the scanning line G4 alone starts to be fed with a high-level scanning voltage. In this way, during the display period of one screen, signal voltages according to image data are written to all the pixel circuits.

The group 6 of detection transistors and the resistor RI together form a logical summation (OR) circuit. When any one or more of the detection transistors are on, the OR circuit outputs a low-level detection signal DG (of, for example, several hundred mV); when all the detection transistors are off, the OR circuit outputs a high-level detection signal DG having a voltage equal to the supply voltage VDD. When the on-state and off-state of a detection transistor are expressed as “true (1)” and “false (0)”, respectively, the detection signal DG represents the logical sum (OR) of the on-state of the detection transistors TG0 to TG4. It should be noted that, in the circuit configuration shown in FIG. 1, a low level and a high level in the detection signal DG represent “true (1)” and “false (0)”, respectively.

Accordingly, when fed with a scanning voltage as described above, the detection transistors TG0 to TG4 turn on one after another; thus, during the display period of one screen, the detection signal DG remains at a low level (of, for example, several hundred mV). In response to this detection signal DG, the first wiring condition detector 5 judges that all the scanning lines are normal.

If, for example, cracks develop where the drive transistors T30, T31, T40, and T41 are formed and make the scanning lines G3 and G4 abnormal (broken, short-circuited, or otherwise defective), the detection signal DG stays at a high level during periods t3 and t4 as shown in FIG. 3. This is because, even though the gate driver 3 feeds a high-level scanning voltage to the scanning lines G3 and G4 during periods t3 and t4, this high-level scanning voltage is not transmitted to the gates of the detection transistors TG3 and TG4, and thus the detection transistors TG3 and TG4 remain off. In response to this detection signal DG, the first wiring condition detector 5 judges that the scanning lines G3 and G4 are abnormal (broken, short-circuited, or otherwise defective). The first wiring condition detector 5 refers not only to the detection signal DG but also to, for example, the above-mentioned timing signal fed to the gate driver 3 so as to be capable of detecting whether the wiring condition of each scanning line is normal or abnormal.

As described above, by detecting, for each scanning line, whether or not a high-level scanning voltage (first-level scanning voltage) for turning on the drive transistors (the corresponding ones among T00 to T44) is transmitted to the gate of the corresponding detection transistor, the first wiring condition detector 5 detects whether each scanning line is normal or abnormal (detects whether or not the transmission across each scanning line is normal or abnormal).

FIG. 1 shows an example in which the drive transistors and the detection transistors are N-channel thin-film transistors. Needless to say, the display unit may be modified so that those transistors are P-channel thin-film transistors. Even in that case, the drive transistors and the detection transistors can be formed on a single substrate by a single process.

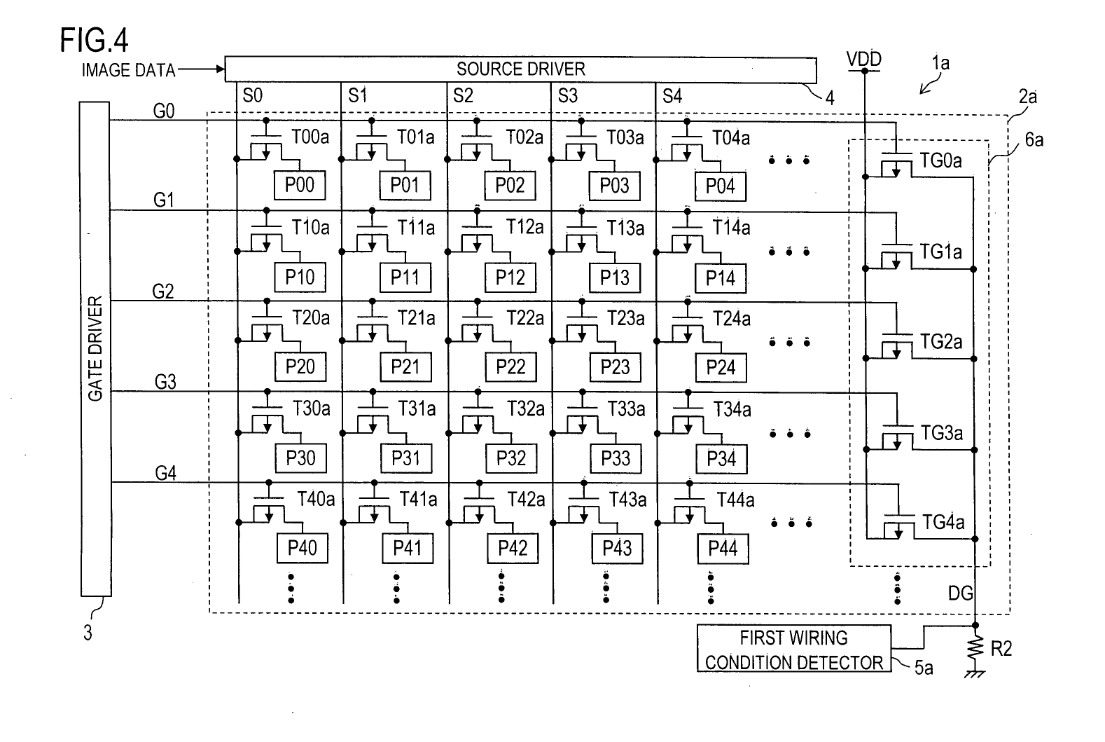

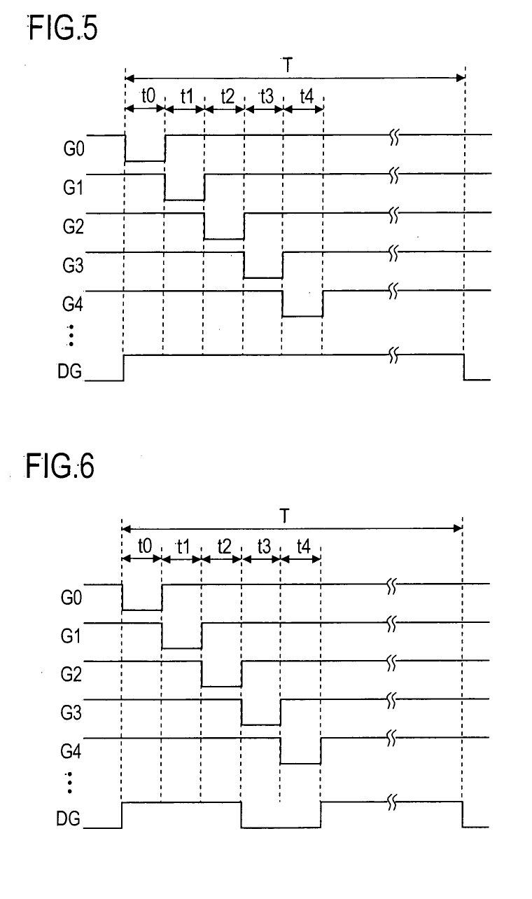

FIG. 4 is a diagram showing the configuration of a display unit 1a including a display panel 2a in which P-channel thin-film transistors (insulated-gate field-effect transistors) are used as drive transistor and detection transistors. FIGS. 5 and 6 are waveform diagrams showing the relationship between the scanning voltage and the detection signal DG over the display period of one screen in the configuration shown in FIG. 4. In FIG. 4, such parts as are the same as in FIG. 1 are identified by common reference signs. In FIGS. 5 and 6, such parts as find their counterparts in FIGS. 2 and 3 are identified by common reference signs. FIG. 5 shows the waveforms observed when all the scanning lines are normal, and FIG. 6 shows the waveforms observed when the scanning lines G3 and G4 are abnormal (broken, short-circuited, or otherwise defective).

The drive transistors T00 to T44 in FIG. 1 are here replaced with P-channel drive transistors (drive switching elements) T00a to T44a. Likewise, the detection transistors TG0 to TG4 in FIG. 1 are here replaced with P-channel detection transistors (detection switching elements) TG0a to TG4a, which thus form a group 6a of detection transistors.

The gates (control electrodes) of the detection transistors TG0a, TG1a, TG2a, TG3a, and TG4a are connected to the scanning lines G0, G1, G2, G3, and G4, respectively. The sources of the detection transistors TG0a to TG4a are connected together so as to be collectively fed with a supply voltage VDD (for example, 5V). Similarly, the drains of the detection transistors TG0a to TG4a are connected together so as to be collectively fed with a reference potential of 0 V via a resistor R2. A detection signal DG appears at the drains (first conducting electrodes), connected together, of the detection transistors TG0a to TG4a, and is fed to a first wiring condition detector 5a, which functions similarly to the first wiring condition detector 5 in FIG. 1.

In the configuration shown in FIG. 4, as shown in FIGS. 5 and 6, the gate driver 3 feeds the scanning lines G0 to G4 sequentially with a low-level scanning voltage (first-level scanning voltage), having a comparatively low voltage, as a scanning voltage for turning the corresponding drive transistors on. In the configuration shown in FIG. 4, a high-level scanning voltage (second-level scanning voltage), having a comparatively high voltage, serves as a voltage for turning the drive transistors off.

In the configuration shown in FIG. 4, when all the scanning lines are normal, the detection transistors TG0a to TG4a turn on one after another, one by one. Thus, during the display period of one screen, the detection signal DG remains at a high level (approximately equal to VDD). In response to this detection signal DG, the first wiring condition detector 5a judges that all the scanning lines are normal. If for example, cracks develop where the drive transistors T30a, T31a, T40a, and T41a are formed and make the scanning lines G3 and G4 abnormal (broken, short-circuited, or otherwise defective), the detection signal DG stays at a low level during periods t3 and t4 as shown in FIG. 6. This is because, even though the gate driver 3 feeds a low-level scanning voltage to the scanning lines G3 and G4 during periods t3 and t4, this low-level scanning voltage is not transmitted to the gates of the detection transistors TG3a and TG4a, and thus the detection transistors TG3a and TG4a remain off. In response to this detection signal DG, the first wiring condition detector 5a judges that the scanning lines G3 and G4 are abnormal (broken, short-circuited, or otherwise defective).

The group 6a of detection transistors and the resistor R2 together form a logical summation (OR) circuit. When any one or more of the detection transistors are on, the OR circuit outputs a high-level detection signal DG (approximately equal to VDD); when all the detection transistors are off, the OR circuit outputs a low-level detection signal DG (0 V). When the on-state and off-state of a detection transistor are expressed as “true (1)” and “false (0)”, respectively, the detection signal DG represents the logical sum (OR) of the on-state of the detection transistors TG0a to TG4a. It should be noted that, in the circuit configuration shown in FIG. 4, a high level and a low level in the detection signal DG represent “true (1)” and “false (0)”, respectively.

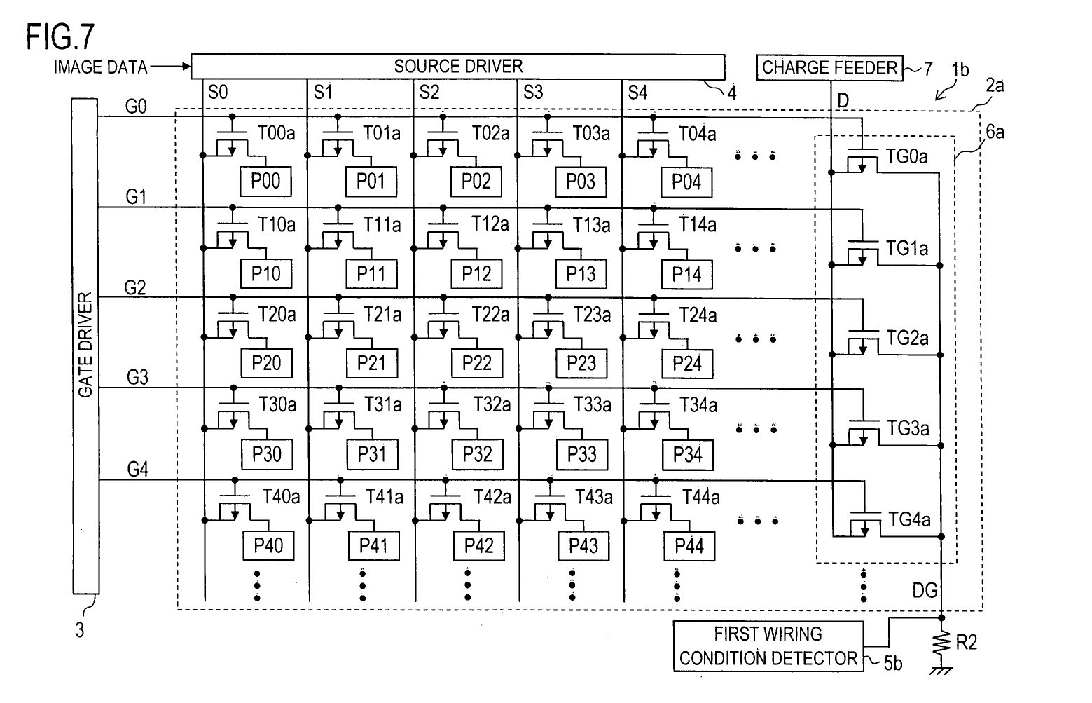

The display unit la shown in FIG. 4 may further be modified to the display unit lb shown in FIG. 7. FIG. 7 is a diagram showing the configuration of the display unit lb. In FIG. 7, such parts as are the same as in FIG. 4 are identified by common reference signs. The display unit 1b of FIG. 7 differs from the display unit 4a of FIG. 4 in that a charge feeder 7 is connected to the sources, connected together, of the detection transistors TG0a to TG4a, and in that the first wiring condition detector 5a is replaced with a first wiring condition detector 5b; in other respects, the display unit 1a and the display unit 1b are the same. The charge feeder 7 feeds electric charge to the line D to which the sources of the detection transistors TG0a to TG4a are connected together.

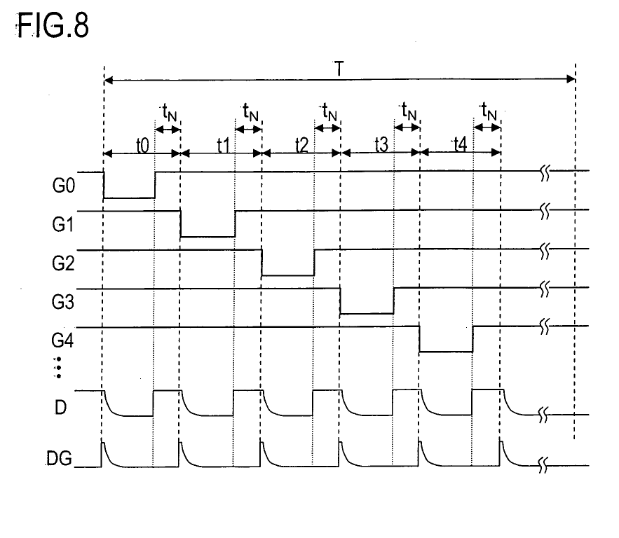

FIG. 8 is a waveform diagram showing the relationship between the scanning voltage and the detection signal DG over the display period of one screen in the configuration shown in FIG. 7. In FIG. 8, such parts as find their counterparts in FIGS. 2, 5, etc. are identified by common reference signs. Although FIG. 5 etc. show as if, for example, when the scanning voltage fed to the scanning line G0 turns from a low level to a high level, simultaneously the scanning voltage fed to the scanning line G1 turns from a high level to a low level, in reality there exists a short non-active subperiod t_{N} between the time points at which they so turn. Such a non-active subperiod t_{N} is set to occur in a last part of each of periods t0 to t4 and have a length equal to about several % to 10% of the length of period t0 (or any one of t1 to t4).

In each non-active subperiod t_{N}, the drive transistors are fed with a scanning voltage such that all of them are off. Specifically, in the configuration shown in FIG. 7, in each of periods t0 to t4, during a first part of it (hereinafter referred to as an “active subperiod”), the gate driver 3 feeds a low-level scanning voltage to the corresponding scanning line to turn the corresponding drive transistors on; during a last part of the same period, that is, during a non-active subperiod t_{N}, the gate driver 3 feeds a high-level scanning voltage to all the scanning lines to turn, or keep, the drive transistors off.

During the non-active subperiod t_{N} of each of periods t0 to t4, the charge feeder 7 feeds electric charge to the line D; for example, it feeds electric charge such that the line D has a potential of about 5 V to 10V. On the other hand, during the active subperiod of each of periods t0 to t4, the output portion of the charge feeder 7 connected to the line D is kept at a high impedance (for example, several tens to several hundred megohms).

Thus, in the active subperiod of each of periods t0 to t4, when the corresponding detection transistor (one of the detection transistors TG0a to TG4a) turns on, the electric charge stored on the line D is discharged via that detection transistor and the resistor R2, and thus a pulse signal appears as the detection signal DG. If, however, the scanning line G3 is abnormal, in period t3, no such discharge takes place, and thus no pulse signal appears as the detection signal DG.

By referring to the presence/absence of pulse signals in the detection signal DG and also to the above-mentioned timing signal fed to the gate driver 3, the first wiring condition detector 5b detects whether the wiring condition of each scanning line is normal or abnormal.

The first wiring condition detector 5b may instead count the number of pulse signals appearing in the detection signal DG during the display period of one screen. This makes it possible to check whether or not any scanning line is abnormal. For example, in a case where the total number of scanning lines is 60, if 60 pulses appear in the detection signal DG during the display period of one screen, it can be judged that all the scanning lines are normal; if 59 or less pulses appear in the detection signal DG during the same period, it can be judged that one or more of the scanning lines are abnormal. This does not allow location of defective spots, but allows judgment of whether the scanning lines are normal or abnormal with a simple configuration. With a configuration according to the first embodiment, it is possible to detect whether or not scanning lines are normal or abnormal on a real-time basis in actual operation, that is, in the middle of an image according to image data being displayed; it is also possible to achieve inspection of scanning lines with an extremely small number of elements.

### Second Embodiment

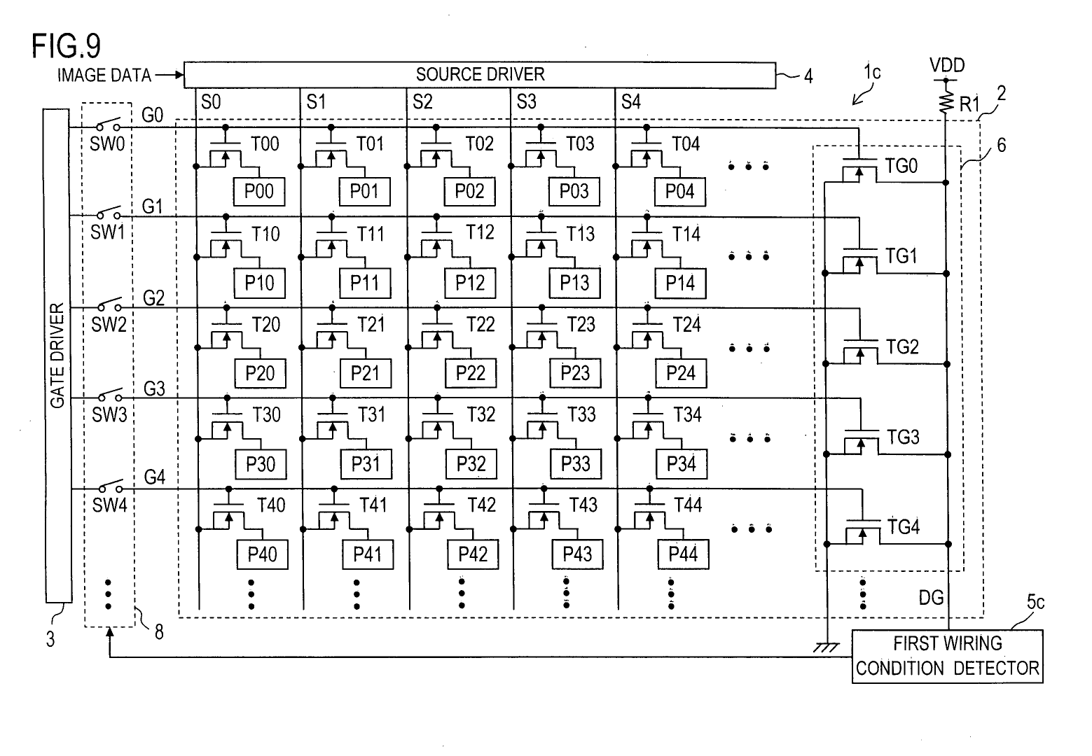

Next, as a modified example of the first embodiment, a second embodiment of the present invention will be described. FIG. 9 is a diagram showing the configuration of a display unit 1c included in a display device according to the second embodiment.

The display unit 1c of FIG. 9 differs from the display unit 1 of FIG. 1 in that a group 8 of protection switches is added, and in that, to cope with that addition, the first wiring condition detector 5 is replaced with a first wiring condition detector 5c; in other respects, the display unit 1 and the display unit 1c are the same. In FIG. 9, such parts as are the same as in FIG. 1 are identified by common reference signs, and no overlapping description of those parts will be repeated.

The group 8 of protection switches consists of the same number of protection switching elements SW0, SW1, SW2, SW3, and SW4 as the total number of scanning lines, with the protection switching elements inserted in the scanning lines G0, G1, G2, G3, and G4, respectively.

The protection switching element SW0 is inserted between the node where the scanning line G0 is connected to the gate driver 3 and the nodes where the scanning line G0 is connected to the gates of the drive transistors T00 to T04, so as to turn on and off the conduction between the former node to the latter nodes according to a control signal from the first wiring condition detector 5c. Likewise, the protection switching element SW1 is inserted between the node where the scanning line G1 is connected to the gate driver 3 and the nodes where the scanning line G1 is connected to the gates of the drive transistors T10 to T14, so as to turn on and off the conduction between the former node to the latter nodes according to a control signal from the first wiring condition detector 5c. A similar description applies to each of the other protection switching elements SW2 to SW4. The protection switching elements SW0 to SW4 are all normally on.

The first wiring condition detector 5c is provided with, in addition to the functions of the first wiring condition detector 5 shown in FIG. 1, the function of outputting the above-mentioned control signal. Based on the detection signal DG, the first wiring condition detector 5c identifies, as an abnormal scanning line, any scanning line that is abnormal (broken, short-circuited, or otherwise defective), and turns off the protection switching element inserted in that abnormal scanning line to stop the drive transistors corresponding to that abnormal scanning line from receiving at their gates the scanning voltages from the gate driver 3.

For example, when the detection signal DG is as shown in FIG. 2, and thus it is judged that all the scanning lines are normal, the first wiring condition detector 5c keeps all the protection switching elements SW0 to SW4 on. By contrast, when the detection signal DG is as shown in FIG. 3, and thus it is judged that the scanning lines G3 and G4 are abnormal (broken, short-circuited, or otherwise defective), the first wiring condition detector 5c identifies the scanning lines G3 and G4 as abnormal scanning lines, and turns the protection switching elements SW3 and SW4 off. This stops the drive transistors T30 to T34 and T40 to T44 corresponding to the scanning lines G3 and G4 from receiving at their gates the scanning voltage from the gate driver 3.

When it is judged that any scanning line is abnormal, it may be short-circuited to a ground line; even in that case, with the protection switching elements provided as described above, it is possible to prevent an abnormal current from continuing to flow. The protection switching elements SW0 to SW4 may be formed, for example, as thin-film transistors (for example, N-channel insulated-gate field-effect transistors) like the drive transistors T00 etc. The protection switching elements SW0 to SW4 may be provided outside the display panel 2 as shown in FIG. 9, or may be provided inside it. In a case where the protection switching elements SW0 to SW4 are provided inside the display panel 2, the protection switching elements SW0 to SW4, the detection transistors TG0 to TG4, and the drive transistors T00 to T44 may be formed on a single substrate by a single process.

In the second embodiment, any feature described previously in connection with the first embodiment may be applied unless inconsistent. Accordingly, for example, in a manner similar to how the display unit 1 of FIG. 1 is modified to the display unit 1a of FIG. 4, the N-channel drive transistors in FIG. 9 may be replaced with P-channel drive transistors. In that case, the circuit configuration around them needs to be modified accordingly. The charge feeder 7 shown in FIG. 7 may also be applied so that whether the scanning lines are normal or abnormal is checked based on pulse signals resulting from discharge of electric charge.

### Third Embodiment

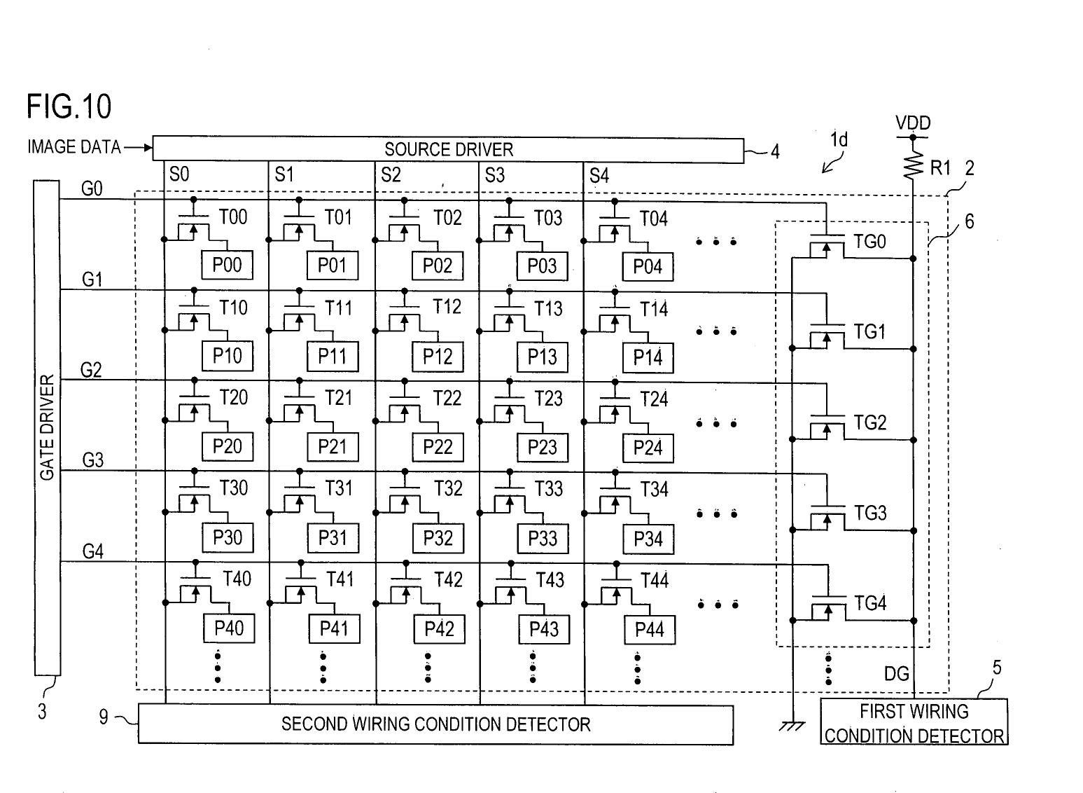

Next, a third embodiment of the present invention will be described. FIG. 10 is a block diagram showing the configuration of a display unit 1d included in a display device according to the third embodiment.

The display unit 1d of FIG. 10 differs from the display unit 1 of FIG. 1 in that the display unit 1 of FIG. 1 is here additionally provided with a second wiring condition detector 9; in other respects, the display unit 1 and the display unit id are the same. In FIG. 10, such parts as are the same as in FIG. 1 are identified by common reference signs, and no overlapping description of those parts will be repeated.

One ends of the signal lines S0 to S4 are connected to the source driver 4, and the other ends (terminal ends) of the signal lines S0 to S4 are connected to the second wiring condition detector 9. Thus, between the node where the signal line S0 is connected to the source driver 4 and the node where the signal line S0 is connected to the second wiring condition detector 9, there lie the nodes where the signal line S0 is connected to the drive transistors T00, T10, T20, T30, and T40. A similar description applies to each of the other signal lines.

As shown in FIG. 11, in periods t0 to t4, the gate driver 3 feeds the scanning lines G0 to G4 sequentially with a high-level scanning voltage. Here, as in the case described previously with reference to FIG. 8, during a last part of each of periods t0 to t4, that is, during a non-active subperiod t_{N}, the gate driver 3 feeds the scanning lines with a scanning voltage such that all the drive transistors stay off. Specifically, in the configuration shown in FIG. 10, in each of periods t0 to t4, during a first part of it (an active subperiod), the gate driver 3 feeds a high-level scanning voltage to the corresponding scanning line to turn the corresponding drive transistors on; during a last part of the same period, that is, during a non-active subperiod t_{N}, the gate driver 3 feeds a low-level scanning voltage to all the scanning lines to turn, or keep, the drive transistors off.

During the active subperiod of each of periods t0 to t4, the source driver 4 feeds signal voltages according to image data to the signal lines S0 to S4. For example, during the active subperiod of period to, the pixel circuits P00 to P04 corresponding to the scanning line G0 are fed with signal voltages according to image data from the source driver 4 via the signal lines S0 to S4 and the drive transistors T00 to T04.

During the non-active subperiods t_{N} of part or all of periods t0 to t4, the source driver 4 feeds the signal lines, including the signal lines S0 to S4, with an inspection voltage having a predetermined level different from those of the above-mentioned signal voltages according to image data. Based on how the inspection voltage is transmitted to it, the second wiring condition detector 9 detects whether the wiring condition of the signal lines is normal or abnormal.

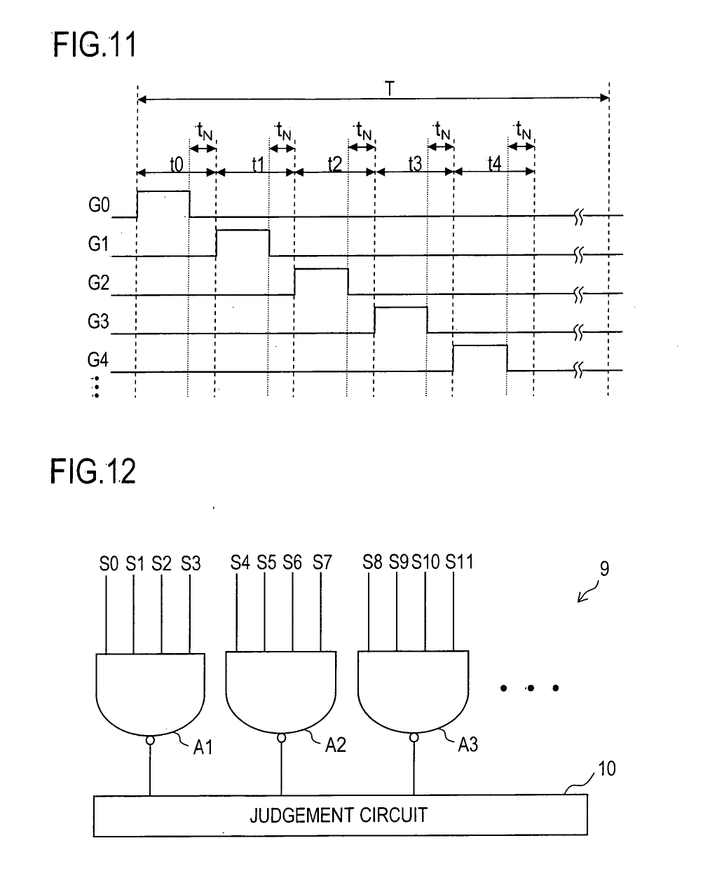

FIG. 12 shows an example of the configuration of the second wiring condition detector 9. The second wiring condition detector 9 shown in FIG. 12 is provided with, or is composed of: a four-input NAND circuit A0 to the different input terminals of which the signal lines S0, S1, S2, and S3 are connected respectively; a four-input NAND circuit Al to the different input terminals of which the signal lines S4, S5, S6, and S7 are connected respectively; a four-input NAND circuit A2 to the different input terminals of which the signal lines S8, S9, S10, and S11 are connected respectively; . . . ; and a judgment circuit 10 that judges whether the signal lines are normal or abnormal based on the outputs of the NAND circuits A0, A1, A2, . . . . The signal lines S5 to S11 are, like signal lines S0 to S4, among the signal lines provided in the display panel 2.

In this configuration, for example, during the non-active subperiod t_{N} of period to, which is the period in which to activate the scanning line G0, the source driver 4 feeds a high-level voltage (corresponding to the above-mentioned inspection voltage) only to the signal lines S0 to S3 and feeds a low-level voltage to the other signal lines. Here, if the signal lines S0 to S3 are all normal, the NAND circuit A0 outputs a low level as its output signal; if at least one of the signal lines S0 to S3 is abnormal, the NAND circuit A0 outputs a high level as its output signal. Meanwhile, the other NAND circuits A1 etc. output a high level as their output signal.

Next, during the non-active subperiod t_{N} of period t1, which is the period in which to activate the scanning line G1, the source driver 4 feeds a high-level voltage (corresponding to the above-mentioned inspection voltage) only to the signal lines S4 to S7 and feeds a low-level voltage to the other signal lines. Here, if the signal lines S4 to S7 are all normal, the NAND circuit A1 outputs a low level as its output signal; if at least one of the signal lines S4 to S7 is abnormal, the NAND circuit A1 outputs a high level as its output signal. Meanwhile, the other NAND circuits A0 etc. output a high level as their output signal. Similar processing is performed with the NAND circuit A2, . . . .

In this configuration, building the judgment circuit 10 with a NAND circuit that receives the output signals of the NAND circuits A0, A1, A2, . . . makes it possible to judge whether every four of the signal lines are normal or abnormal. For example, if the signal line S0 is abnormal, during the non-active subperiod t_{N} of period t0, the NAND circuit A0 outputs a high level, and thus the NAND circuit forming the judgment circuit 10 outputs a low level as its output signal. By referring not only to this low-level output signal but also to the above-mentioned timing signal, it is possible to judge that at least one of the signal lines S0 to S3 is abnormal. Alternatively, during the non-active subperiods t_{N} of part or all of periods t0 to t4, the source driver 4 may feed a high-level voltage (corresponding to the above-mentioned inspection voltage) to all the signal lines simultaneously. With this configuration, based on each of the output signals of the NAND circuits A0, A1, A2, . . . outputted simultaneously during those non-active subperiods t_{N}, the judgment circuit 10 can judge whether every four of the signal lines are normal or abnormal. As described above, the signal lines provided in the display panel 2 are divided into a plurality of signal line blocks, and the signal lines belonging to each signal line block (for example, in the above example, the signal lines A0 to A3 connected to the NAND circuit A0) are connected to one NAND circuit, so that whether the signal lines are normal or abnormal is judged on a block-by-block basis. Although each signal line block consists of four signal lines in the above example, this number is merely given as an example and may be changed; for example, each signal line block may consist of 32 to 128 signal lines.

The second wiring condition detector 9 is, for example, fabricated as a circuit separate from the display panel 2 so as to be externally fitted to it. In a case where no detection of whether or not the scanning lines are normal or abnormal is necessary, the first wiring condition detector 5, the group 6 of detection transistors, and the resistor R1 in the display unit Id shown in FIG. 10 may be omitted.

In a manner similar to how the display unit 1 of FIG. 1 is modified to the display unit 1a of FIG. 4, the N-channel drive transistors in FIG. 10 may be replaced with P-channel drive transistors. In that case, the circuit configuration around them needs to be modified accordingly. This embodiment may be combined with the second embodiment (FIG. 9) so that the configuration of this embodiment is additionally provided with the group 8 of protection switches shown in FIG. 9.

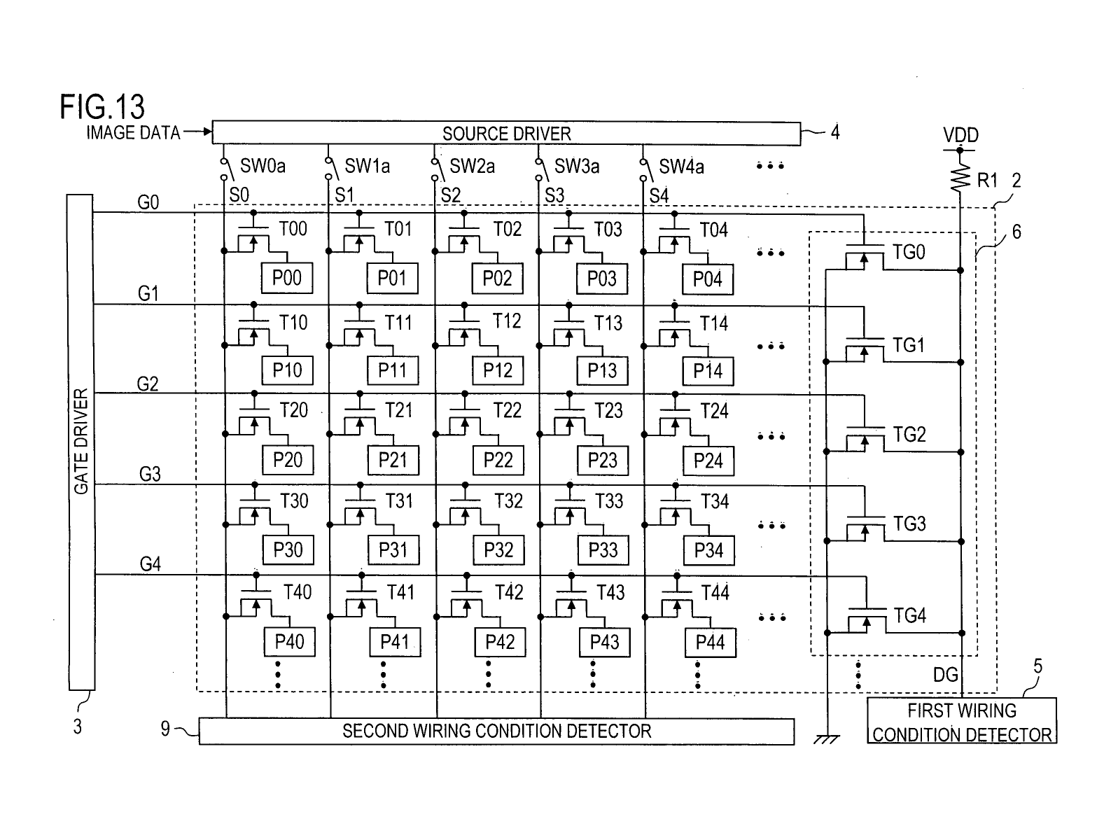

In a manner similar to how the display unit 1 of FIG. 1 is modified to display unit 1c of FIG. 9, as shown in FIG. 13, the same number of protection switching elements SW0a, SW1a, SW2a, SW3a, and SW4a as the total number of signal lines may be additionally provided, with the protection switching elements inserted in the signal lines S0, S1, S2, S3, and S4, respectively.

The protection switching element SW0a is inserted between the node where the signal line S0 is connected to the source driver 4 and the nodes where the signal line S0 is connected to the sources of the drive transistors T00, TI0, T20, T30, and T40, so as to turn on and off the conduction between the former node to the latter nodes according to a control signal from the second wiring condition detector 9. Likewise, the protection switching element SW1a is inserted between the node where the signal line S1 is connected to the source driver 4 and the nodes where the signal line S1 is connected to the sources of the drive transistors T01, T11, T21, T31, and T41, so as to turn on and off the conduction between the former node to the latter nodes according to a control signal from the second wiring condition detector 9. A similar description applies to each of the other protection switching elements SW2a to SW4a. The protection switching elements SW0a to SW4a are all normally on.

In this configuration, based on how the above-mentioned inspection signal is transmitted to it, the second wiring condition detector 9 identifies, as an abnormal signal line, any signal line across which transmission is abnormal (one that does not transmit the above-mentioned inspection signal), and turns off the protection switching element inserted in that abnormal signal line to stop the drive transistors corresponding to that abnormal signal line from receiving at their sources the output voltages (signal voltages etc.) of the source driver 4.

For example, in a case where the second wiring condition detector 9 is configured as shown in FIG. 12, if it is judged that at least one of the signal lines S0 to S3 is abnormal, the second wiring condition detector 9 identifies the signal lines S0 to S3 as abnormal scanning lines (an abnormal scanning line block), and turns the protection switching elements SW0a to SW3a off. This stops the drive transistors connected to the signal lines S0 to S3 from receiving at their sources the output voltages of the source driver 4. Needless to say, when it is judged that all the signal lines are normal, all the protection switching elements SW0a to SW4a are turned, or kept, on.

When it is judged that any signal line is abnormal, it may be short-circuited to a ground line; even in that case, with the. protection switching elements provided as described above, it is possible to prevent an abnormal current from continuing to flow.

The protection switching elements SW0a to SW4a may be formed, for example, as thin-film transistors (for example, N-channel insulated-gate field-effect transistors) like the drive transistors T00 etc. The protection switching elements SW0a to SW4a may be provided outside the display panel 2 as shown in FIG. 13, or may be provided inside it. In a case where the protection switching elements SW0a to SW4a are provided inside the display panel 2, the protection switching elements SW0a to SW4a, the detection transistors TG0 to TG4, and the drive transistors T00 to T44 may be formed on a single substrate by a single process.

With a configuration according to the second embodiment, it is possible to detect whether or not signal lines are normal or abnormal on a real-time basis in actual operation, that is, in the middle of an image according to image data being displayed

### Fourth Embodiment

Next, a vehicle-mounted system incorporating a display unit according to one of the first to third embodiments described above will be described as a fourth embodiment of the present invention. The following description deals with, as an example, a vehicle-mounted system incorporating a display unit 1d (FIG. 10) according to the third embodiment.

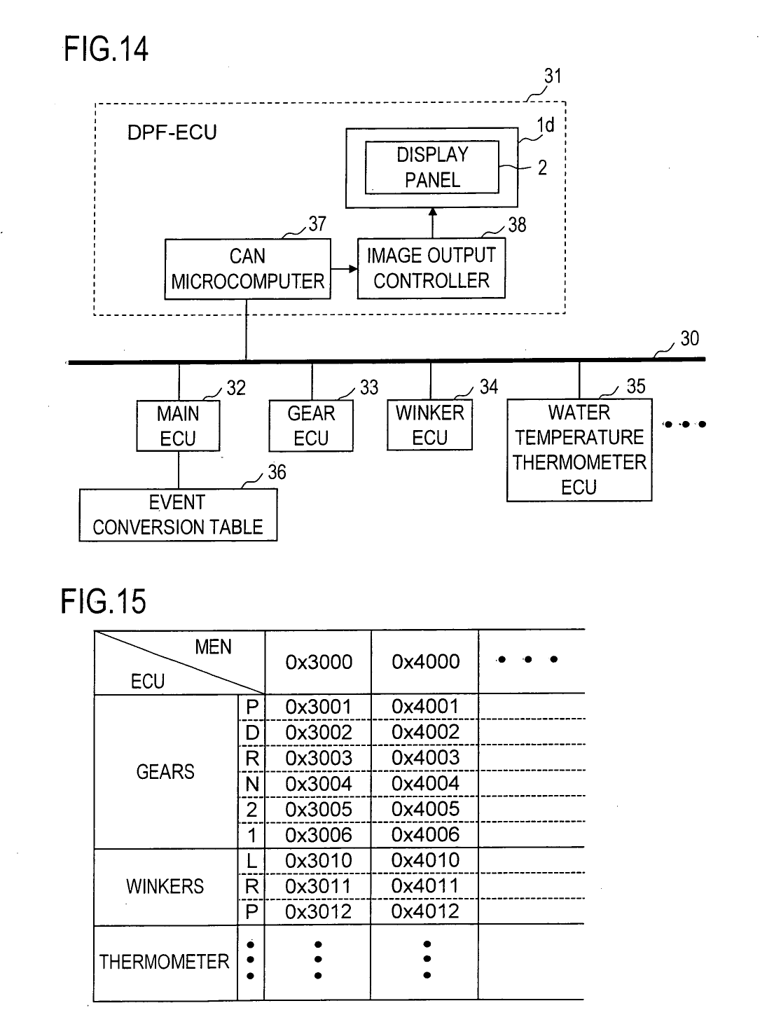

The vehicle-mounted system includes, or is built with, a vehicle instrument panel (display platform-electrical control unit, abbreviated to DPF-ECU). FIG. 14 is a diagram showing the overall configuration of the vehicle-mounted system incorporating the display unit id (FIG. 10). This vehicle-mounted system is installed on an unillustrated vehicle such as an automobile.

A DPF-ECU 31, a main ECU (electrical control unit) 32, a gear ECU 33, a winker ECU 34, and a water temperature thermometer ECU 35 are connected to a CAN (controller area network) bus 30 so as to be bidirectionally communicable with one another across the CAN bus 30.

The gear ECU 33 monitors and controls the state of gears (unillustrated) provided in the vehicle. The winker ECU 34 monitors and controls the state of blinkers (unillustrated) provided in the vehicle. The water temperature thermometer ECU 35 monitors the temperature indicated by a water thermometer (unillustrated) provided in the vehicle; that is, it monitors the temperature of coolant fluid. The DPF-ECU 31 has, or is composed of: the display unit ld including a display panel 2; a CAN microcomputer 37; and an image output controller 38.

The main ECU 32 determines a main event number (hereinafter abbreviated to “MEN”) that specifies the overall layout of the screen to be displayed on the display panel 2 provided in the display unit 1d. In addition, based on information on the state of the gears from the gear ECU 33, information on the state of the blinkers from the winker ECU 34, and information on the above-mentioned temperature from the water temperature thermometer ECU 35, the main ECU 32 also determines a sub event number (hereinafter abbreviated to “SEN”) that specifies the layouts of parts of the screen to be displayed on the display panel 2 provided in the display unit 1d.

Referring to an event conversion table 36 having contents, for example, as shown in FIG. 15, the main ECU 32 determines an SDN (scene design number) having a MEN and a SEN put together. The main ECU 32 determines the SDN periodically such that, every 10 ms, the determined SDN is transmitted to the CAN microcomputer 37 provided in the DPF-ECU 31; simultaneously, along with the SDN, information on the traveling speed of the vehicle, information on the rotation speed of a crank shaft (unillustrated) of an engine, etc. is also transmitted to the CAN microcomputer 37.

The CAN microcomputer 37 then transmits the received SDN to the image output controller 38. Here, the received SDN may first be subjected to predetermined processing before being transmitted to the image output controller 38. Based on the SDN thus received, the image output controller 38 controls the display unit 1d and transmits image data to the source driver 4 so that an image with a screen layout according to the SDN is displayed on the display panel 2 provided in the display unit 1d.

In this way, the main ECU 32 determines the screen layout according to the state of the gears etc., and the display panel 2 displays, in a periodically refreshed fashion, an image with a screen layout according to the state of the gears etc.

At a time point that no refreshing of the screen is specified in the event data file referred to by the main ECU 32, the same SDN as previously transmitted is once again transmitted to the DPF-ECU 31. Also, if, in response to the SDN transmitted from the main ECU 32, no acknowledgment of completion of its reception is returned from the DPF-ECU 31, or an error notification indicating an error in its reception is returned, even when transmission of a next SDN is requested in the above-mentioned event data file, the same SDN as previously transmitted is once again transmitted to the DPF-ECU 31.

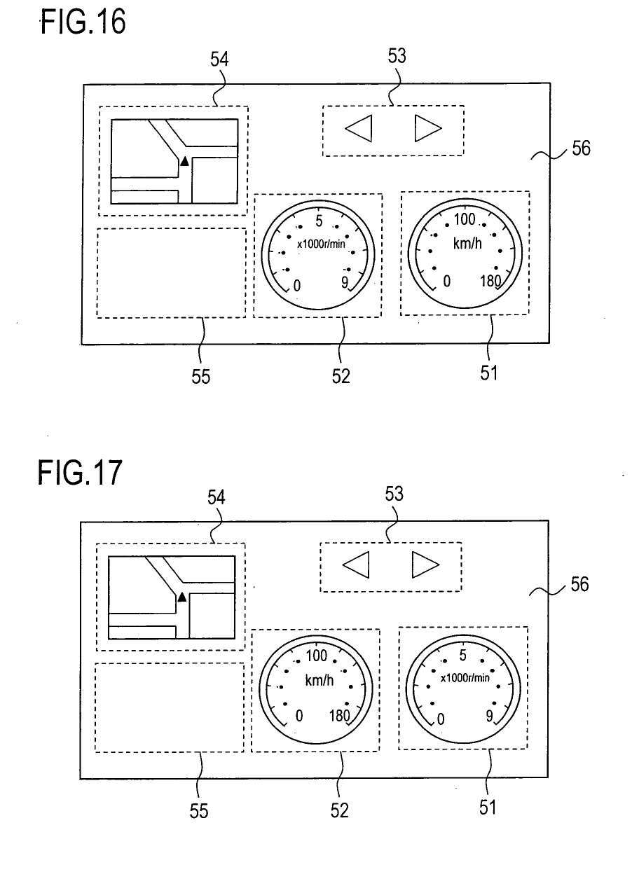

FIGS. 16 and 17 show examples of screen layouts determined by the main ECU 32 for display on the display panel 2. In the screen layouts shown in FIG. 16 and 17, the display area of the display panel 2 is divided into subareas 51, 52, 53, 54, and 55 and the remaining subarea 56 for separate use. Display of an image in a given area is always achieved with the same drive transistors and pixel circuits. Screen layouts like those shown in FIGS. 16 and 17 are designed beforehand and stored in a memory or the like, and information that identifies those screen layouts is referred to by the main ECU 32 and the DPF-ECU 31.

In the screen layouts shown in FIGS. 16 and 17, the area 53 is allotted to the display of the state of the blinkers, the area 54 is allotted to the display of a map around the vehicle, and the area 55 is allotted to the display of the state of the gears etc. In the screen layout shown in FIG. 16, the area 51 is allotted to the display of the traveling speed (for example, 0 to 180 km/hour) of the vehicle, and the area 52 is allotted to the display of a tachometer (for example, 0 to 9 000 rpm) indicating the above-mentioned rotation speed. In the screen layout shown in FIG. 17, reversely, the area 51 is allotted to the display of a tachometer, and the area 52 is allotted to the display of the traveling speed of the vehicle.

Suppose now that, while an image is being displayed on the display panel 2 with the screen layout shown in FIG. 16, some of the signal lines for feeding signal voltages to the pixel circuits for displaying the image in the area 51 have become abnormal. For example, assume that, in a case where the signal lines for feeding signal voltages to the pixel circuits for displaying the image in the area 51 consist of signal lines S200 to S263, it is judged that the signal lines S200 to S231 have become abnormal while the signal lines other than the signal lines S200 to S231 are normal. This judgment is made by the second wiring condition detector 9 configured as shown in FIG. 12. Here, the signal lines S200 to S263 (unillustrated) are, like the signal lines S0 to S4, among the signal lines provided in the display panel 2.

The result of the judgment of whether the signal lines are normal or abnormal by the second wiring condition detector 9 is transmitted via the CAN microcomputer 37 and the CAN bus 30 to the main ECU 32. The main ECU 32 distinguishes the different degrees of display precedence assigned to the different kinds of information displayed on the display panel 2. In the screen layouts shown in FIG. 16 and 17, the information on the traveling speed of the vehicle is assigned a higher degree of display precedence than the information on the rotation speed. This is because loss of display of the traveling speed of the vehicle greatly diminishes the safety of travel of the vehicle.

In response to the result of the above-mentioned judgment of whether the signal lines are normal or abnormal, the main ECU 32 changes the SDN such that the screen layout is changed from the one shown in FIG. 16 to the one shown in FIG. 17. That is, it instantaneously changes the screen layout such that the information (image) on the traveling speed, which has up to now been displayed in the area 51, is from now on displayed in the area 52 and that the information (image) on the rotation speed, which has up to now been displayed in the area 52, is from now on displayed in the area 51. The changed SDN is transmitted via the CAN bus 30 etc, to the image output controller 38, so that the screen layout on the display panel 2 is changed from the one shown in FIG. 16 to the one shown in FIG. 17.

As described above, if, while information with a higher degree of display precedence (in the above example, the traveling speed of the vehicle) is being displayed in a first area (in the above example, the area 51), the first area has come to involve a pixel circuit corresponding to an abnormal signal line, then the information with the higher degree of display precedence is thereafter displayed on a second area different from the first area. The second area involves no pixel circuit corresponding to an abnormal signal line. This helps maintain accurate display of information with so high a degree of display precedence that impaired display of it may lead to a serious hazard (in the above example, the traveling speed of the vehicle).

Although the above description deals with an example in which a signal line has become abnormal, a scanning line that has become abnormal can be coped with similarly. Specifically, if, while information with a higher degree of display precedence is being displayed in a first area, the first area has come to involve a pixel circuit corresponding to an abnormal scanning line, then the information with the higher degree of display precedence is thereafter displayed on a second area different from the first area. The second area involves no pixel circuit corresponding to an abnormal scanning line.

Needless to say, even if a scanning line and a signal line have become abnormal simultaneously, they can be coped with similarly. Specifically, if, while information with a higher degree of display precedence is being displayed in a first area, the first area has come to involve a pixel circuit corresponding to an abnormal scanning and/or signal line, then the information with the higher degree of display precedence is thereafter displayed on a second area different from the first area. The second area involves no pixel circuit corresponding to an abnormal scanning and/or signal line.

### Modifications and Variations

In the embodiments described above, the gate driver 3 functions as a scanning line driver, the source driver 4 functions as a signal line driver. In the fourth embodiment, the image output controller 38 functions as an image data outputter. The image data outputter may be regarded as being composed of the image output controller 38 and the main ECU 32.

### INDUSTRIAL APPLICABILITY

The present invention offers display panels such as liquid crystal display panels, organic EL (electroluminescence) display panels, inorganic EL display panels, and plasma display panels, and is suitable for display devices incorporating such display panels. The present invention is also suitable for vehicle-mounted systems incorporating such display devices.

1. A display panel
having a plurality of scanning lines and a plurality of signal lines formed to form a matrix, and
having, respectively at intersections between the scanning lines and the signal lines,
drive switching elements turned on and off according to scanning voltages fed to the scanning lines and
pixel circuits connected via the drive switching elements to the signal lines,
wherein
the display panel has detection switching elements of which control electrodes are connected respectively to the scanning lines, and
first conducting electrodes of the detection switching elements are connected together so that, from the first conducting electrodes thus connected together, a detection signal representing a logical sum of any on-state among the detection switching elements is outputted.

2. The display panel according to claim 1, wherein
the detection switching elements each turn on when receiving at control electrodes thereof a first-level scanning voltage that turns the drive switching elements on, and
turn off when receiving at the control electrodes thereof a second-level scanning voltage that turns the drive switching elements off.

3. The display panel according to claim 2, wherein
the drive switching elements and the detection switching elements are transistors formed on a single substrate by a single process.

4. A display device comprising:
the display panel according to claim 2;
a scanning line driver feeding the first-level scanning voltage to one after another of the scanning lines; and
a first wiring condition detector detecting, based on the detection signal, wiring condition of the scanning lines one by one.

5. A display device comprising:
the display panel according to claim 3;
a scanning line driver feeding the first-level scanning voltage to one after another of the scanning lines; and
a first wiring condition detector detecting, based on the detection signal, wiring condition of the scanning lines one by one.

6. The display device according to claim 4, wherein
the scanning voltage from the scanning line driver is fed to the scanning lines via first protection switching elements provided one for each of the scanning lines, and
the first wiring condition detector identifies as an abnormal scanning line any scanning line across which transmission of the first-level scanning voltage to a corresponding one of the detection transistors is abnormal, and turns off a corresponding one of the first protection switching elements which is inserted in the thus identified abnormal scanning line.

7. The display device according to claim 5, wherein
the scanning voltage from the scanning line driver is fed to the scanning lines via first protection switching elements provided one for each of the scanning lines, and
the first wiring condition detector identifies as an abnormal scanning line any scanning line across which transmission of the first-level scanning voltage to a corresponding one of the detection transistors is abnormal, and turns off a corresponding one of the first protection switching elements which is inserted in the thus identified abnormal scanning line.

8. The display device according to claim 4, further comprising:
a signal line driver connected to first ends of the signal lines; and
a second wiring condition detector connected to second ends of the signal lines,
wherein
while the scanning line driver is feeding the second-level scanning voltage to all the scanning lines, the signal line driver feeds an inspection voltage having a predetermined level to the signal lines so that, based on how the inspection voltage is transmitted, the second wiring condition detector detects wiring condition of the signal lines.

9. A display device having
a display panel
having a plurality of scanning lines and a plurality of signal lines formed to form a matrix, and
having, respectively at intersections between the scanning lines and the signal lines,
drive switching elements turned on and off according to scanning voltages fed to the scanning lines and
pixel circuits connected via the drive switching elements to the signal lines,
a signal line driver connected to first ends of the signal lines, and
a scanning line driver feeding one after another of the scanning lines with a first-level scanning voltage that turns the drive switching elements on,
wherein the display device further comprises:
a second wiring condition detector connected to second ends of the signal lines.
wherein
while the scanning line driver is feeding all the scanning lines with a second-level scanning voltage that turns the drive switching elements off, the signal line driver feeds an inspection voltage having a predetermined level to the signal lines so that, based on how the inspection voltage is transmitted, the second wiring condition detector detects wiring condition of the signal lines.

10. The display device according to claim 9, wherein
the signal line driver is connected to the signal lines via second protection switching elements provided one for each of the signal lines, and
the second wiring condition detector identifies as an abnormal signal line any signal line across which transmission of the inspection voltage to the second wiring condition detector is abnormal, and turns off a corresponding one of the second protection switching elements which is inserted in the thus identified abnormal signal line.

11. The display device according to claim 5, further comprising:
a signal line driver connected to first ends of the signal lines; and
a second wiring condition detector connected to second ends of the signal lines,
wherein
while the scanning line driver is feeding the second-level scanning voltage to all the scanning lines, the signal line driver feeds an inspection voltage having a predetermined level to the signal lines so that, based on how the inspection voltage is transmitted, the second wiring condition detector detects wiring condition of the signal lines.

12. The display device according to claim 6, further comprising:
a signal line driver connected to first ends of the signal lines; and
a second wiring condition detector connected to second ends of the signal lines,
wherein
while the scanning line driver is feeding the second-level scanning voltage to all the scanning lines, the signal line driver feeds an inspection voltage having a predetermined level to the signal lines so that, based on how the inspection voltage is transmitted, the second wiring condition detector detects wiring condition of the signal lines.

13. The display device according to claim 7, further comprising:
a signal line driver connected to first ends of the signal lines; and
a second wiring condition detector connected to second ends of the signal lines,
wherein
while the scanning line driver is feeding the second-level scanning voltage to all the scanning lines, the signal line driver feeds an inspection voltage having a predetermined level to the signal lines so that, based on how the inspection voltage is transmitted, the second wiring condition detector detects wiring condition of the signal lines.
